(19) United States
(12) Patent Application Publication
(10) Pub. No.: US 2004/0248065 A1
(43) Pub. Date: Dec. 9, 2004

(54) Self-fabricated denture

(76) Inventor: Sidney Schneider, Morristown, NJ (US)

Correspondence Address: BENJAMIN APPELBAUM, PH.D., ATTORNEY AT LAW, 27 BENNINGTON DRIVE, FLANDERS, NJ, 07836, US

(21) Appl. No.: 10/751,076

(22) Filed: Jan. 2, 2004

Related U.S. Application Data
(60) Provisional application No. 60/475,977, filed on Jun. 6, 2003.

(51) Int. Cl. A61C 13/02

(52) U.S. Cl. 433/168.1

(57) ABSTRACT

Embodiments include either a lower denture, an upper denture without a palate or a set of dentures containing a layer of a dental reline material. Ready made embodiments selected by an edentulous individual user are fitted by immersion in warm water to soften the reline material, fitting the denture within the mouth, and exerting a biting force on the denture for a period of a few minutes. In this time, the reline material conforms to the mouth and gums of the individual user, providing a ready made denture that can be fitted by the individual user without the necessity of having impressions made and numerous fittings by a dental professional.

### CROSS REFERENCES TO RELATED APPLICATIONS

This application claims the benefit of U.S. Provisional Patent Application Ser. No. 60/475,977, filed 6 Jun. 2003, the contents of which are incorporated by reference herein.

### FIELD OF THE INVENTION

An embodiment of the present invention is a ready made denture intended for use by edentulous persons, which can be fitted by the individual user, eliminating the need for numerous trips to a dental professional for custom fitting and preparation, and which is available at a greatly reduced cost. Embodiments include an upper denture, a lower denture, or a set including both an upper and a lower denture. The denture includes a layer of a heat-moldable denture reline material, and by immersion in heated water for several minutes can be adapted to fit an individual's mouth. After the reline material has softened, the user inserts the denture into their mouth, presses it against the gum to fit, with the reline material conforming to the shape of the individual's gum.

### BACKGROUND OF THE INVENTION

The use of fluoride in community water systems, or application of topical fluoride treatments by dental professionals, and improved toothbrushing appliances and dental care products, among others, have resulted in people maintaining their natural teeth for much, if not all, of their lifetime. People still may lose some or all of their teeth, through improper dental care, accident, disease or other reasons. Artificial teeth, inserted into the mouth in the form of dentures, have been known for centuries, with improvements made in the materials used and methods of manufacture thereof. But the use of dentures has generally required that the person make several trips to the dentist, over a period ranging from several days to several weeks or longer, with one visit for the taking of an impression, and one or more for fitting and adjustment of the dentures. The costs associated with preparing such dentures can be high, and the discomfort associated with both the fitting process and sometimes the wearing of dentures prevents some people from obtaining or using them. Consequently, some people choose to remain edentulous, or to live with missing teeth, rather than obtain dentures.

Prior art patents disclose cosmetic dentures, and various methods to prepare dentures.

For example, Albert et al. (U.S. Pat. No. 5,951,291) disclose a cosmetic accessory for teeth, the device including a gum portion and a tooth portion shaped and dimensioned to cover the user's upper or lower front teeth. The device, preferably manufactured from a room-temperature curable material, such as silicone, is held in place by custom fitted inner projections that match the spaces between the user's own front teeth.

Ginsburg et al. (U.S. Pat. No. 5,775,900) disclose a method of producing and fitting stents and temporary dentures using their thermodeformable characteristics. The stent or the temporary denture is heated to a temperature above 120 degrees F., such that these devices become malleable and may be molded in the mouth or on a model of the patient to attain an approximation of the tissue surfaces. U.S. Pat. No. 5,304,063 discloses a method of producing and fitting complete dentures, using a thermoformable material.

In U.S. Pat. No. 5,451,498 Hazen discloses a cosmetic denture which covers existing teeth and gums and is created from an impression mold of the user's teeth and gums; the denture is not permanently affixed to the teeth. By contrast, embodiments of the present invention do not require that an impression be made of the individual patient's mouth.

Huybrechts (U.S. Pat. No. 5,431,563 discloses a thermoplastic moldable composition and products manufactured using this composition. The composition can be used to prepare custom denture liners, orthotics for hands and feet, and other uses, by heating the molded article at an elevated temperature (over 50 degrees C., usually between 50 degrees C. and 95 degrees C.). The inventor notes a problem created by obtaining an absolutely perfect fit: inserting and removing it may be extremely difficult if not impossible for the patient.

In U.S. Pat. No. 4,705,476 Blair discloses a method and apparatus to produce artificial dentures using full arch upper and lower sets of artificial teeth connected together, and opposite sides of each arch formation are braced to stabilize their shape.

Hazar (U.S. Pat. No. 4,470,815) discloses a method of making custom dentures from an uncured resin module. The module is molded to one of three standard sizes, and includes sockets for the insertion of artificial teeth. The module is cooled to a low temperature to impart rigidity to it, and to prevent curing of the resin. In use, teeth are inserted into the module, which is then conformed to a heated cast representation of the patient's oral cavity, and the module itself is then heated to cure the module, thereby providing a custom fit. Once the teeth have been inserted into the module and their positions adjusted, the module containing the teeth is immersed in hot water to effect curing. The heating step in Hazar effects curing and keeps the teeth fixed, whereas embodiments of the present invention use a heating step to soften the denture enabling it to be molded to the user's oral cavity.

In U.S. Pat. No. 6,077,075, Bedard et al. disclose a dental appliance and process in which a laminate material is made flexible by heating it at a temperature which is tolerable to the body, for example, roughly 20 degrees F. above body temperature, immediately prior to its installation.

Wagner (U.S. Pat. No. 4,401,616) discloses heating of a blank sheet of thermoplastic material to a temperature above its softening point, after which the softened material is placed over a built-up study model of the jaw ridge of a patent requiring a dental prosthesis, and cooled to substantially rigid condition to form a custom dental impression tray.

In U.S. Pat. No. 4,024,636 Colpitts et al. disclose dentures consisting of teeth anchored in a gum member composed of a mass of a polyurethane foam elastomer, such as that commonly used in insulation materials.

Monroy (U.S. Pat. No. 4,881,543) discloses a rapid denture technique, based upon the use of a full arch of artificial teeth, wherein the dentures are fabricated from a light-curable dental material.

Although several references disclose heating dentures to varying temperatures above a human's body temperature, none of these references, either alone or in combination, teach the use of a denture including a layer of reline material or silicone, which when heated, can then be fitted within the mouth of an individual in need of a denture without requiring the assistance of another individual or a person skilled in the dental arts. Upper denture embodiments of the present invention lack a palate, thereby reducing the amount of material needed to manufacture the denture, and which adds to the comfort of the denture when won by an individual.

In a prior patent (U.S. Pat. No. 3,838,513), this inventor has described a method for forming a denture in situ in the mouth of an individual. This method required the user to perform numerous steps to make an impression; such steps included the application of an adhesive to the tray, mixing and application of alginate impression material, and positioning a spacer atop the impression material, prior to inserting the tray into the mouth to form the impression. The present invention eliminates these steps; the use of a layer of reline material in the tray enables the denture to be readily fitted by the individual with a minimum number of steps.

Thus, there is a long-felt need for inexpensive dentures which can be readily fitted by edentulous persons, without entailing numerous visits to a dental professional, and which can be provided at a relatively low cost compared to the use of custom prepared dentures. Embodiments of the present invention meet this need, which also includes a method for using these denture embodiments.

### BRIEF SUMMARY OF THE INVENTION

An objective of embodiments of the present invention is to enable a person to fabricate their own denture directly in the mouth without the assistance of a professional. The materials used in the device are readily available to dentists and denturists and are commonly used in dental procedures, although not necessarily used in the manner described herein.

Starting with a replica of an edentulous arch in a molded form, artificial dentures are formed. Embodiments of the present invention include either a lower denture, an upper denture without a palate or a set of dentures containing a layer of a dental reline material. Part of the denture includes a tray which forms an impression against the gums of the individual by means of a reline acrylic material or a silicone pad within the tray. The silicone acrylic pad is placed in warm water for a few minutes and is placed into the mouth and will form directly, molding to the gums. The bite will adjust itself to the opposing bite allowing the denture to balance between the fit and the occlusion, providing a ready made denture that can be fitted by the individual user without the necessity of having impressions made and numerous fittings by a dental professional.

### DESCRIPTION OF THE SEVERAL VIEWS OF THE DRAWINGS

FIG. 1 is a perspective view of a denture embodiment of the present invention.

FIG. 2 is a cross-sectional view taken along line 2-2 of FIG. 1.

FIG. 3 shows how the dentures are fitted within the user's mouth by the teeth articulating together.

### DETAILED DESCRIPTION OF THE INVENTION

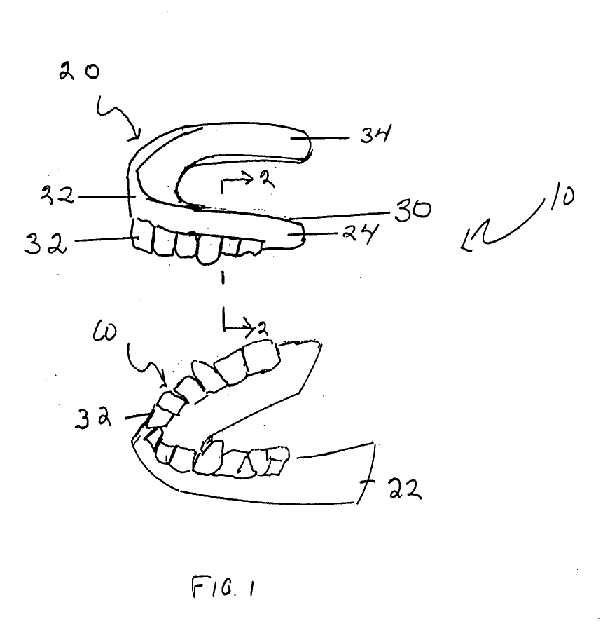

An embodiment of the present invention is shown in FIG. 1 as a set of dentures 10, which may comprise an upper denture 20 and a lower denture 60. Embodiments of the present invention can be either a complete set of dentures 10, or as individual upper denture 20 or lower denture 60. As shown in the Figures, the upper denture embodiment 20 is made without a palate, so that the lower denture embodiment 60 and upper denture embodiment 20 are generally similar to each other.

FIG. 1 illustrates the upper denture embodiment of the present invention, but the description of the upper denture 20 is also applicable to the lower denture embodiment 60, and reference numerals for the upper denture 20 are applicable to lower denture 60. Each denture comprises what will be referred to herein as a tray 22 which is generally U-shaped. Tray 22 includes a pair of outer walls 24, inner walls 26 and a channel 28 between walls 26. The outer walls 22 meet the inner walls 26 forming a flange 30. A plurality of artificial teeth 32 are mounted in the tray 22, and extend from the tray as shown. The teeth 32 are mounted within the tray using techniques known to those skilled in the art. A layer of heat-deformable material 34 (FIGS. 1, 2) is applied to the tray 22 and fills the channel 28. After the heat deformable material 34 has solidified, it conforms to the shape of the channel and walls, forming a gum-receiving member 34.

As used within the context of the present specification, deformable means formable or shapeable only at temperatures above room temperature (approximately 66-71 degrees F.); i.e., deformable means heat formable. The term “formable”, as used within the present specification, means formable or shapeable at either about room temperature or at elevated temperature.

Each tray (whether for an upper or a lower denture) is prepared from a master replica of an edentulous arch using standard dental molding methods and materials. In this manner, each tray has the contour of a typical arch found in the mouth of an adult. The tray 22 can be prepared by vacuum-forming from a sheet of material, or by other techniques such as injection-molding or blow-molding.

The materials for the tray include methyl methacrylate, ethyl methacrylate, and other longer chain alkyl methacrylates. A representative acrylic resin can be made from a mixture of methyl methacrylate liquid monomer, a methyl methacrylate polymer powder, and a plasticizer such as diethyl phthalate, dioctyl phthalate, and mixtures thereof, or other suitable plasticizers known to those skilled in the art. Other agents that can be used include polyethyl methacrylate, polypropyl methacrylate or polybutyl methacrylate.

The tray may be a molded form which includes a plurality of individual cavities to receive a set of artificial teeth. Either a plurality of individual teeth 32 may be placed in the cavities, or the teeth 32 may be formed by pouring a mixture of shaded acrylic material into the cavities, which will then form the individual teeth and become attached to the tray after curing. Curing is effected using the curing process appropriate to the particular materials, as known to those skilled in the art.

The teeth inserted into the tray are designed to be almost a complete set, representing the incisors, cuspids, bicuspids and the first molar; second and third molars may or may not be included, because many adults often do not have their second and/or third molars. The teeth can be colored in different shades.

After the tray has been formed and the teeth added, the reline material 34 is applied to the cured denture, and the reline material 34 allowed to cure as appropriate for the particular material; the reline material conforms to the shape of the channel.

The reline material is selected from any of the soft, heat deformable reline materials commercially available as known to those skilled in the art. This can be either an acrylic reline material, a silicone reline material, or a silicone pad. Embodiments of the present invention employ a cushion material liner. One example of a silicone reline material is sold under the trademark MOLLOSIL® (Buffalo Dental Manufacturing Co., Inc, Syosset N.Y.); both acrylic and silicone reline materials sold by Dentsply International, York Pa., or distributors such as Darby-Spencer-Mead Dental Supply Co (Westbury N.Y.).

The thickness of the reline material is generally in the range of about 1 mm to about 5 mm, but a thickness of about 1.5-3 mm is generally used. The optimum materials for making and fitting the dentures 20 and 60 are best selected by a modest amount of experimentation and observation by those of ordinary skill in the art.

In use, the individual selects the appropriate size and type of denture desired, i.e., whether upper, lower or both. It is generally accepted that there is not a great deal of variation in the sizes of the mouth of adult human beings; it is possible to manufacture the denture with just a few basic sizes, knowing that they can be custom fitted to an individual provided that the proper size is selected at the outset. Thus, a distributor of embodiments of the present invention would only be required to carry a few sizes from which the user would make their selection.

Where necessary, the selected denture may be shortened by cutting or filing, or the length of the teeth may be shortened by grinding or filing. The denture is then placed in warm water (using a quantity of warm water for a period of time sufficient for the layer of reline material to become soft). Generally, the temperature of the water is greater than ambient temperature (generally 18 degrees C.-21 degrees C., or between 66-71 degrees F.) but less than 100 degrees C. (212 degrees F.). The temperature of the water can be from approximately 38 degrees C. (approximately 100 degrees F.) to approximately 95 degrees C. (approximately 204 degrees F.); or the temperature of the water can be from approximately 45 degrees C. (approximately 112 degrees F.) to approximately 80 degrees C. (approximately 176 degrees F.); or the temperature of the water can be from approximately 51 degrees C. to approximately 58 degrees C. (approximately 125 degrees F. to approximately 135 degrees F.). Depending upon the temperature of the water, this is generally between 2 to 10 minutes. Once the layer of reline material 34 has become softened, the denture is removed from the warm water, and is inserted into the person's mouth. The manner of use will vary depending whether the person is using only a single, i.e., a lower or an upper, denture, or a set of dentures (both lower and upper). In an embodiment of the present invention, the user should maintain the denture at a temperature of between approximately 125 degrees F. to approximately 135 degrees F., and generally for between approximately 6 to approximately 8 minutes for the material to become sufficiently soft and adaptable to the user's gums.

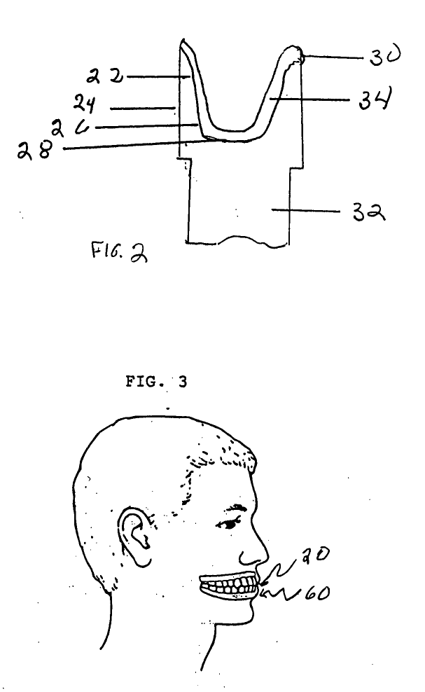

For an upper denture, the denture is positioned onto the user's arch, where it can be held in position using finger pressure, such as being held in place by the person's thumbs. If the person has lower teeth, after positioning the upper denture, the person bites down and holds the bite for a few minutes (such as 2-3 minutes; FIG. 3). By biting for several minutes, the bite of the denture adjusts itself to the opposing bite allowing the denture to balance between the fit and the occlusion.

If the person is using both upper and lower dentures, after positioning each denture on the appropriate arch, the person bites down and holds the bite for a few minutes (such as 2-3 minutes). During this time period, the force exerted onto the reline material by the individual enables the softened reline material 34 to conform to the contours of the person's gums, and as the reline material 34 cools it retains these contours, forming a denture that fits the person's mouth. There is no need to mix reagents to form impressions, no need to remove excess impression material, or have excess impression ooze into one's mouth, which often causes the person to gag, and no need to remove impression material from the denture once it has been fitted.

Embodiments of the present invention can include a kit form, the dentures supplied as either a complete set (both upper and lower dentures), or as a lower or an upper denture, with instructions for use. For convenience, the denture may be produced in one of three sizes, a small, medium and a large size.

Embodiments of the present invention can be used in a method for forming a denture in situ in the mouth of an edentulous person. By following simple illustrated instructions, individuals can readily fabricate their own dentures without the assistance of a professional, although if the person so chooses, the assistance of a dental professional may be used. This inventor believes embodiments of the present invention represent the first time an edentulous patient can use the unique application and prepared prosthesis.

An advantage provided by the present invention in the in situ formation of dentures include the need to have available only a limited number of tray sizes to have a tray of an appropriate size for most persons. Other advantages include the ability of the denture to conform uniformly to the arch of the person; the ability to form a denture in which the outer surfaces of the gums simulate the contours of the actual outer gum surfaces of the person; and because the reline material is soft, embodiments of the present invention include the ability to accommodate high spots on the arch or undercuts in dental surfaces without causing discomfort to the person, as is common when a rigid denture material is used.

Another advantage of the direct molding process employed to make the denture used in the present invention is the elimination of the palate of the upper denture. This effects a cost savings, because a lot less material is used in the denture, but more importantly, it makes using the upper denture embodiment of the present invention less stressful than that associated with conventional dentures which include the palate. In conventional upper dentures that include a palate, the palate is a major source of discomfort for the wearer, because of difficulties in conforming it to the shape of the individual, and the presence of a hard palate within the mouth.

The present invention's method of forming the denture in situ in the mouth of an individual eliminates the need for making an impression, the try-in of dentures, and the use of dental materials that may be uncomfortable. The method and materials employed in the present invention may also be more favorable to the dental tissue of the user. Delivery of the denture to the user is immediate, whereas the conventional method of denture manufacture and fitting may take weeks of processing.

Therefore, although this invention has been described with a certain degree of particularity, it is to be understood that the present disclosure has been made only by way of illustration and that numerous changes in the details of construction and arrangement of parts may be resorted to without departing from the spirit and scope of the invention.

I claim:

1. A denture comprising:
a tray including outer walls, inner walls, a channel between the inner walls, a flange, the flange formed by the meeting of the inner and the outer walls, the tray being generally U-shaped, and a tooth receiving portion;
a plurality of teeth in the tooth receiving portion; and
a layer of gum receiving material, the gum receiving material applied to the inner walls and flange, thereby forming a gum receiving member; the gum receiving member being deformable when subjected to a temperature greater than ambient temperature but less than 100 degrees C. (212 degrees F.), the reline material conforming to the configuration of a gum received within the gum-receiving member.

2. The denture as described in claim 1, wherein the gum receiving material is a denture reline material.

3. The denture as described in claim 2, wherein the reline material is selected from the group consisting of acrylic reline material and silicone reline material.

4. The denture as described in claim 3, wherein the gum is a gum of a user of the denture.

5. The denture as described in claim 4, wherein the denture is an upper denture, and the upper denture does not include a palate.

6. The denture as described in claim 4, wherein the reline material has a thickness between approximately 1 mm and approximately 5 mm.

7. A method for fitting a denture in situ in the mouth of an individual, the method comprising the steps of:
selecting the denture to fit the individual, the denture comprising:
a tray including outer walls, inner walls, a channel between the inner walls, a flange, the flange formed by the meeting of the inner and the outer walls, the tray being generally U-shaped, and a tooth receiving portion;
a plurality of teeth in the tooth receiving portion; and
a layer of gum receiving material, the gum receiving material applied to the inner walls and flange, thereby forming a gum receiving member; the gum receiving member being deformable when subjected to a temperature greater than ambient temperature but less than 100 degrees C. (212 degrees F.);
preparing the selected denture by heating the selected denture to a temperature greater than ambient temperature but less than 100 degrees C. (212 degrees F.);
positioning the prepared denture within the mouth, the gum receiving member receiving a gum of the individual; and
fitting the denture by the application of a force to the denture.

8. The method as described in claim 7, wherein the force is a biting force.

9. The method as described in claim 8, wherein the force is applied for a time period sufficient for the gum receiving member to conform to the gum.

10. The method as described in claim 9, wherein the time period is between approximately 1 minute and approximately 30 minutes.

11. The method as described in claim 9, wherein the heating step comprises immersion of the selected denture in water at a temperature between approximately 38 degrees C. and approximately 95 degrees C.

12. The method as described in claim 11, wherein the heating step comprises immersion of the selected denture in water at a temperature between approximately 45 degrees C. and approximately 80 degrees C.

13. The method as described in claim 11, further comprising the step of fitting a second denture in the mouth, the second denture being fitted in opposition to the first denture.

14. The method as described in claim 13, wherein the individual is edentulous.

15. The method as described in claim 13, wherein the first denture is selected from the group consisting of a lower denture and an upper denture.

16. A kit for fitting a denture in situ in the mouth of an individual, the kit comprising:
a denture, comprising:
a tray including outer walls, inner walls, a channel between the inner walls, a flange, the flange formed by the meeting of the inner and the outer walls, the tray being generally U-shaped, and a tooth receiving portion;
a plurality of teeth in the tooth receiving portion; and
a layer of gum receiving material, the gum receiving material applied to the inner walls and flange, thereby forming a gum receiving member; the gum receiving member being deformable when subjected to a temperature greater than ambient temperature but less than 100 degrees C. (212 degrees F.); the reline material conformable to the configuration of an item received within the gum-receiving member; and
a set of instructions.

17. The kit as described in claim 16, wherein the denture is selected from the group consisting of an upper denture; a lower denture; and an upper denture and a lower denture.

18. The kit as described in claim 16, wherein the upper denture does not include a palate.

19. An upper denture comprising:
a tray including outer walls, inner walls, a channel between the inner walls, a flange, the flange formed by the meeting of the inner and the outer walls, and a tooth receiving portion;
a plurality of teeth in the tooth receiving portion; and
a layer of gum receiving material, the gum receiving material applied to the inner walls and flange, thereby forming a gum receiving member; the gum receiving member being deformable when subjected to a temperature greater than ambient temperature but less than 100 degrees C. (212 degrees F.);
the tray being generally U-shaped and lacking a palate.

20. A denture for being fitted in situ in the mouth of an individual in need of a denture, the denture comprising:
a tray including outer walls, inner walls, a channel between the inner walls, a flange, the flange formed by the meeting of the inner and the outer walls, the tray being generally U-shaped, and a tooth receiving portion;
a plurality of teeth in the tooth receiving portion; and
a layer of denture reline material, the denture reline material selected from the group consisting of acrylic reline material and silicone reline material, the reline material applied to the inner walls and flange, thereby forming a gum receiving member, the gum receiving member being deformable when subjected to a temperature greater than ambient temperature but less than 100 degrees C. (212 degrees F.), the reline material conforming to the configuration of a gum received within the gum-receiving member.
